(19) United States
(12) Patent Application Publication
(10) Pub. No.: US 2011/0320960 A1
(43) Pub. Date: Dec. 29, 2011

(54) FLEXIBLE AUTOMATIC REPLY FEATURES FOR TEXT MESSAGING

(76) Inventors: Yigang Cai, Naperville, IL (US); Suzann Hua, Lisle, IL (US)

(21) Appl. No.: 12/825,864

(22) Filed: Jun. 29, 2010

(51) Int. Cl. H04W 4/12; G06F 15/16; G06F 3/01

(52) U.S. Cl. 715/752; 455/466

(57) ABSTRACT

Systems and methods are disclosed for providing automatic reply features that send a personalized reply message to a sender of a text message. In one embodiment, a system includes a network interface that receives information on a text message sent to a recipient that has activated an automatic reply feature. The system further includes a control system that processes the text message information to identify a sender of the text message, selects a reply message predefined by the recipient based on the sender of the text message, and sends the selected reply message to the sender of the text message through the network interface.

### FIELD OF THE INVENTION

The invention is related to the field of communication networks and, in particular, to automatic reply features for text messaging.

### BACKGROUND

Text messaging has become a popular mode of communication in many wireless communication networks. One example of text messaging is Short Message Service (SMS), which is a communication protocol allowing the exchange of short text messages (i.e., 160 characters) between mobile devices. While the term “text message” traditionally referred to text-only messages sent using SMS, it has been extended to include multimedia messages, such as images, video, sound content, etc. The multimedia messages may be sent using Multimedia Message Service (MMS) protocol.

The automatic reply feature, also referred to as an Out of Office Assistant, a vacation response feature, etc, is a service that automatically responds to incoming text messages with a reply message. An end user may program the automatic reply feature to send reply message that acknowledge receipt of a text message, that provide alternate contact information, that indicate when a response can be expected, etc. To implement the automatic reply feature, the end user accesses a user interface for the automatic reply feature, and defines a reply message, a start date, and end date. When the automatic reply feature receives an incoming text message addressed to the end user, the automatic reply feature responds to the incoming text message with the reply message specified by the end user. The reply message is typically in the form of a text message.

### SUMMARY

Embodiments described herein provide enhanced automatic reply features for text messages that are more flexible than those presently implemented. Present automatic reply features send the same reply message in response to each incoming text message. Instead of using the same reply message for each incoming text message, the embodiments described herein allow an end user to send personalized reply messages based on the sender of the text message and possibly other criteria. For example, the user may define different reply messages for his/her boss, spouse, friends, etc. When a text message is received for the end user, the automatic reply feature identifies the sender of the text message, and sends the proper reply message based on the identified sender. Thus, the end user is given more flexibility in what reply messages are sent through the automatic reply feature.

One embodiment comprises a system that provides automatic reply messages. The system includes a network interface operable to receive information on a text message sent to a recipient that has activated an automatic reply feature. The system further includes a control system operable to process the text message information to identify a sender of the text message, to select a reply message predefined by the recipient based on the sender of the text message, and to send the selected reply message to the sender of the text message through the network interface.

In another embodiment, the system further includes a user interface operable to allow the recipient to enter sender identities and a reply message that is predefined for each of the sender identities. The system further includes a storage system operable to store entries that associate the sender identities with the reply messages. With the entries stored in the storage system, the control system is operable to access the entries in the storage system to select the reply message predefined by the recipient based on the sender of the text message.

In another embodiment, the control system is further operable to identify a location of the sender of the text message, and to select the reply message based on the sender of the text message and the location of the sender.

In another embodiment, the control system is further operable to identify a location of the recipient, and to select the reply message based on the sender of the text message and the location of the recipient.

In another embodiment, the control system is further operable to process the text message information to determine information on a time/day that the text message was sent, and to select the reply message based on the sender of the text message and the time/day information.

In another embodiment, the control system is further operable to process the text message information to identify a language of the text message, and to select the reply message based on the sender of the text message and the language of the text message.

In another embodiment, the control system is further operable to identify an on/off status of a mobile device of the recipient, and to select the reply message based on the sender of the text message and the on/off status of the mobile device of the recipient.

In another embodiment, the control system is further operable to store an indication that the selected reply message was delivered to the sender of the text message.

In another embodiment, the control system is further operable to determine whether a prior reply message was sent to the sender during a time period, and to halt the selected text message from being sent to the sender responsive to a determination that the prior reply message was sent.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a mobile network in an exemplary embodiment.

FIG. 2 illustrates an automatic reply system in an exemplary embodiment.

FIG. 3 is a flow chart illustrating a method of sending reply messages for an automatic reply feature in an exemplary embodiment.

FIG. 4 is a flow chart illustrating a method of selecting a reply message based further on the location of the sender in an exemplary embodiment.

FIG. 5 is a flow chart illustrating a method of selecting the reply message based further on the location of the recipient in an exemplary embodiment.

FIG. 6 is a flow chart illustrating a method of selecting the reply message based further on time/day information in an exemplary embodiment.

FIG. 7 is a flow chart illustrating a method of selecting the reply message based further on the language of the text message in an exemplary embodiment.

FIG. 8 is a flow chart illustrating a method of selecting the reply message based further on the on/off status of the mobile device of the recipient in an exemplary embodiment.

FIG. 9 is flow chart illustrating a method of determining whether to send the selected reply message in an exemplary embodiment.

FIG. 10 illustrates a user interface for the automatic reply feature in an exemplary embodiment.

FIG. 11 illustrates a user interface with additional reply criteria in an exemplary embodiment.

FIG. 12 illustrates a communication system in an exemplary embodiment.

FIG. 13 is a message diagram illustrating an example of providing a personalized reply message in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

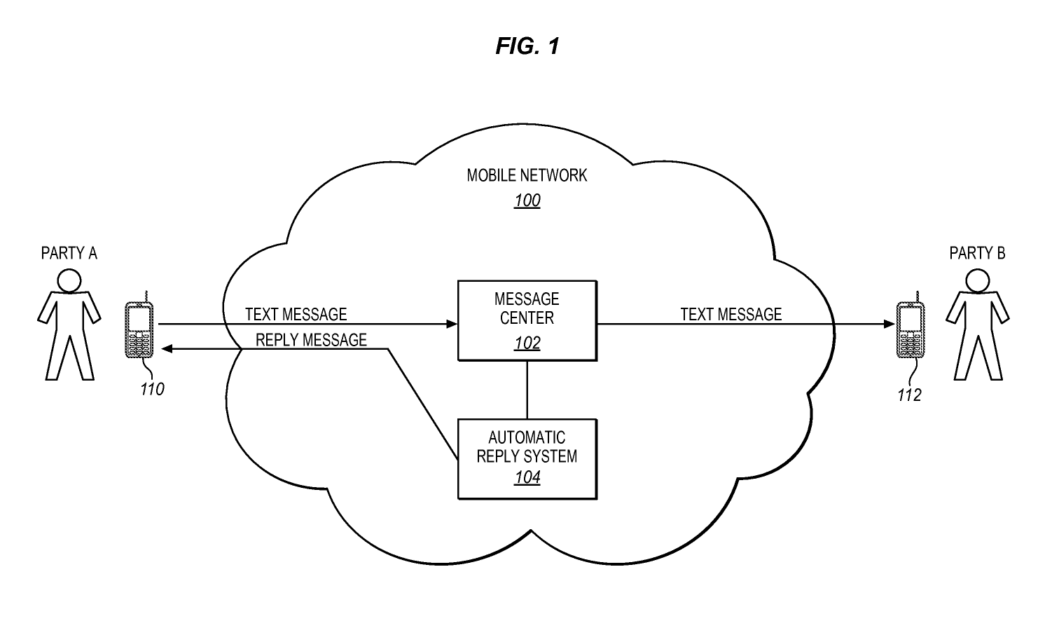

FIG. 1 illustrates a mobile network 100 in an exemplary embodiment. Mobile network 100 may comprise a circuit-based network, such as a CDMA network or a GSM network, may comprise a packet-based network, such as an IP Multimedia Subsystem (IMS) network, or a mix of the two. Mobile network 100 includes a message center 102 and an automatic reply system 104. Message center 102 comprises any system, server, or device operable to facilitate the delivery of text messages. For example, message center 102 may comprise an SMS Center (SMSC) that implements SMS protocol to deliver text or SMS messages. In another example, message center 102 may comprise an MMS Center (MMSC) that implements MMS protocol to deliver multimedia or MMS messages. Automatic reply system 104 comprises any system, server, or device that provides reply messages to senders of text messages as part of an automatic reply feature. Automatic reply system 104 may be implemented as a stand alone server (as illustrated in FIG. 1), or may be implemented within other network elements of mobile network 100, such as message center 102.

Mobile network 100 is able to facilitate the delivery of a text message between a mobile device 110 of Party A (sender) and a mobile device 112 of Party B (recipient). Party B has subscribed to an automatic reply feature offered by mobile network 100. According to the embodiments provided herein, when Party A sends a text message to Party B, automatic reply system 104 is able to select a reply message that is predefined for Party A. Thus, instead of sending a generic reply message in response to the text message, automatic reply system 104 is able to send a personalized reply message that is specifically tailored to the sender (Party A).

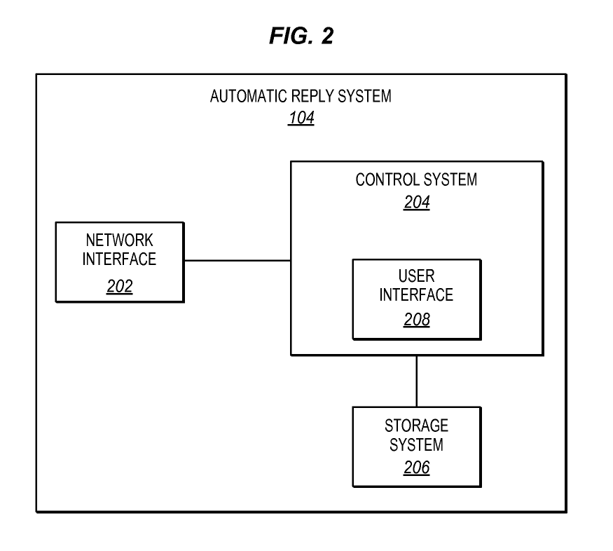

FIG. 2 illustrates automatic reply system 104 in an exemplary embodiment. Automatic reply system 104 includes a network interface 202 that is operable to exchange communications with other elements in mobile network 100, such as message center 102. Automatic reply system 104 further includes a control system 204 operable to select reply messages for the automatic reply feature. Automatic reply system 104 further includes a storage system 206 operable to store reply criteria used for the automatic reply feature in selecting the reply messages, to store the predefined reply messages, and other data. Control system 204 is operable to provide a user interface 208, which is a web-based interface or another type of interface, that allows subscribers of the automatic reply feature to define the reply criteria, the reply messages, etc.

In FIG. 1, assume for example that Party A sends a text message to Party B. The text message is received by message center 102. Message center 102 includes a store-and-forward system (not shown) that utilizes SMS protocol or another type of store-and-forward protocol for delivering text messages to their destinations. Upon initially receiving the text message, the store-and-forward system in message center 102 first stores (persistently) the text message, and then initiates a delivery attempt for the text message to mobile device 112 of Party B. If the first delivery attempt is unsuccessful, then the store-and-forward system enters a retry process.

In addition to message center 102 attempting delivery of the text message to mobile device 112, automatic reply system 104 is informed of the text message that was sent to mobile device 112 of Party B. This may occur in a variety of ways. Message center 102, responsive to receiving the text message, may send information on the text message to automatic reply system 104. The information on the text message may comprise a copy of the text message, or some data describing the text message. Alternatively, another network element (not shown) in mobile network 100 that handles the text message may make a copy or may send other information on the text message to automatic reply system 104. For example, when mobile device 110 registers with mobile network 100, a serving network element (not shown) will be assigned to mobile device 110. The serving network element may comprise a Mobile Switching Center (MSC) in a circuit-based network, or may comprise a Call Session Control Function (CSCF) in a packet-based IMS network. The serving network element receives the text message from mobile device 110 and sends the text message to message center 102. The serving network element may send information on the text message to automatic reply system 104.

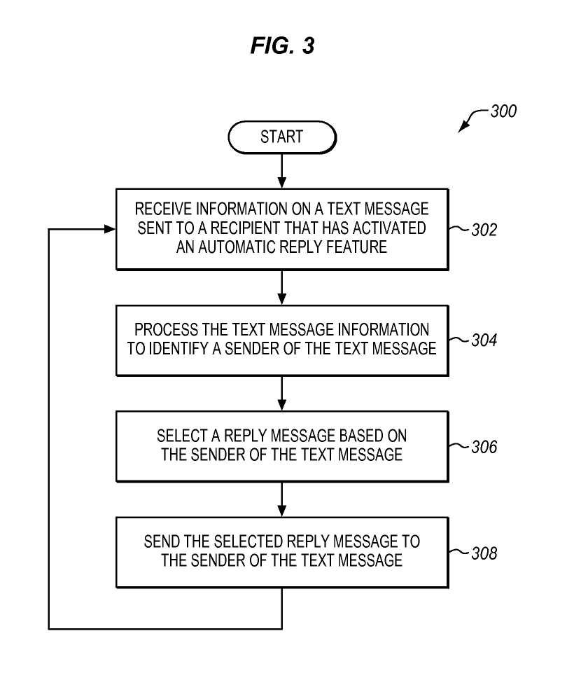

Party B has activated an automatic reply feature for text messages. Thus, automatic reply system 104 will send a reply message to the sender (Party A) as described further in FIG. 3.

FIG. 3 is a flow chart illustrating a method 300 of sending reply messages for an automatic reply feature in an exemplary embodiment. The steps of method 300 are described with reference to mobile network 100 in FIG. 1 and automatic reply system 104 in FIG. 2, although method 300 may be performed in other networks or systems. The steps of the flow charts described herein are not all inclusive and may include other steps not shown. The steps may also be performed in an alternative order.

In step 302, network interface 202 in automatic reply system 104 receives the information on the text message that was sent from Party A (the sender) to Party B (the recipient). In step 304, control system 204 processes the text message information to identify the sender (i.e., Party A) of the text message. The sender of the text message may be identified in a variety of ways. For example, control system 204 may process the text message information to identify a Mobile Directory Number (MDN), an IP address, a URL, an email address, a name, etc. In step 306, control system 204 selects a reply message based on the sender of the text message. Looking at FIG. 2, storage system 206 may store a plurality of entries that include reply messages that have been predefined by Party B for senders of text messages. The entries are indexed by, or otherwise associated with, a sender ID. Thus, when control system 204 identifies the sender of the text message, control system 204 is able to identify a reply message that was predefined by Party B and is specific to the sender. In step 308, control system 204 sends the selected reply message to the sender (i.e., Party A) of the text message through network interface 202. To do so, control system 204 may format the selected reply message as a text message (also referred to as a reply text message), and forward the reply text message to message center 102. Message center 102 may then forward the reply text message to Party A.

The process described in FIG. 3 is repeated for each text message that is received for Party B while the automatic reply feature is activated. Thus, each reply message that is sent is personalized for the sender of the text message. This advantageously gives Party B flexibility in the content that is provided through the automatic reply feature, instead of sending a generic reply message to all senders.

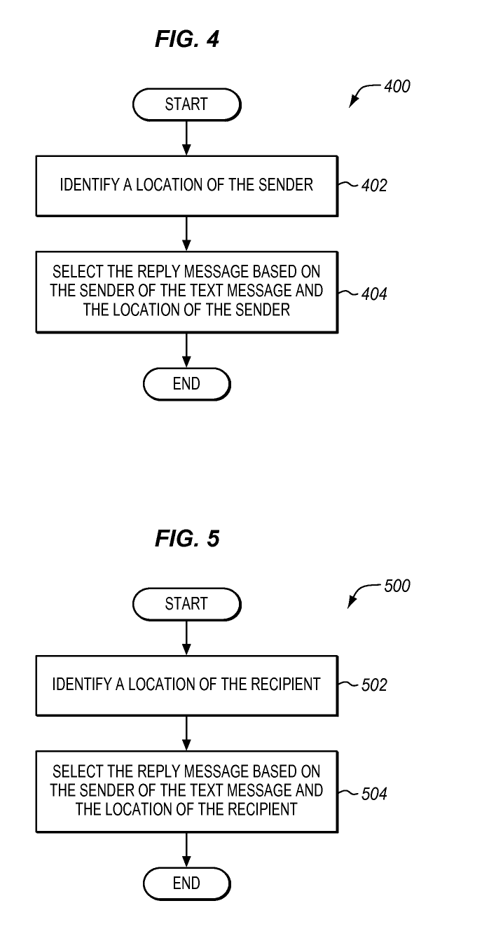

In the above embodiment, control system 204 selects the reply message based on the sender of the text message. However, control system 204 may process additional criteria or rules when selecting the reply message. The additional criteria are referred to herein as “reply criteria” that are also predefined by Party B. FIGS. 4-8 show additional methods of selecting the reply message based on the reply criteria.

In one embodiment, the reply criteria may additionally include the location of the sender of the text message. FIG. 4 is a flow chart illustrating a method 400 of selecting the reply message based further on the location of the sender in an exemplary embodiment. In step 402, control system 204 identifies a location of the sender of the text message (see also FIG. 2). To perform step 402, control system 204 may process the text message information, may query a location server (not shown) in mobile network 100 based on a sender ID, such as the MDN, etc. In step 404, control system 204 selects the reply message based on the sender of the text message and the location of the sender.

In another embodiment, the reply criteria may additionally include the location of the recipient of the text message. FIG. 5 is a flow chart illustrating a method 500 of selecting the reply message based further on the location of the recipient in an exemplary embodiment. In step 502, control system 204 identifies a location of the recipient of the text message (see also FIG. 2). To perform step 502, control system 204 may process the text message information, may query a location server (not shown) in mobile network 100 based on a recipient ID, such as the MDN, etc. In step 504, control system 204 selects the reply message based on the sender of the text message and the location of the recipient.

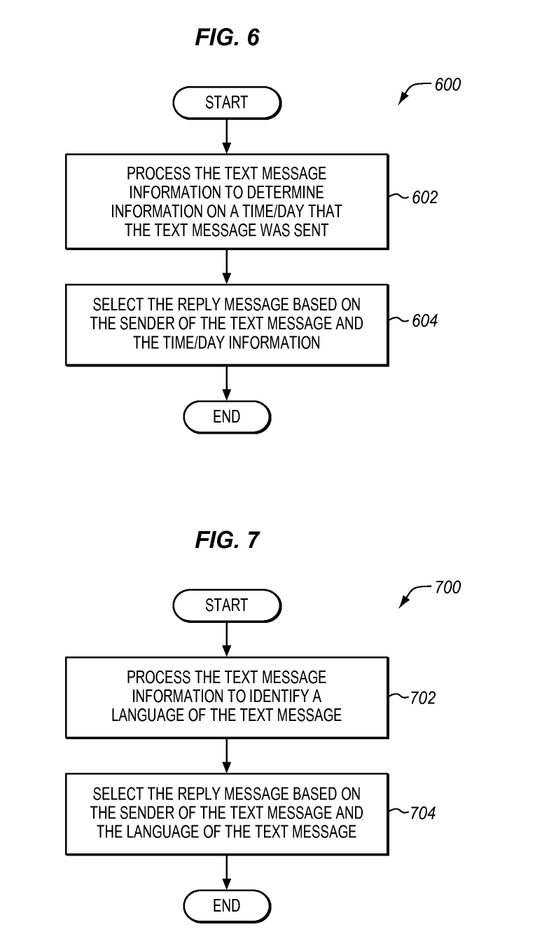

In another embodiment, the reply criteria may additionally include the time or day that the text message was sent. FIG. 6 is a flow chart illustrating a method 600 of selecting the reply message based further on time/day information in an exemplary embodiment. In step 602, control system 204 processes the text message information to determine information on a time/day that the text message was sent (see also FIG. 2). In step 604, control system 204 selects the reply message based on the sender of the text message and the time/day information.

In another embodiment, the reply criteria may additionally include the language of the text message. FIG. 7 is a flow chart illustrating a method 700 of selecting the reply message based further on the language of the text message in an exemplary embodiment. In step 702, control system 204 processes the text message information to identify a language of the text message (see also FIG. 2). In step 704, control system 204 selects the reply message based on the sender of the text message and the language of the text message.

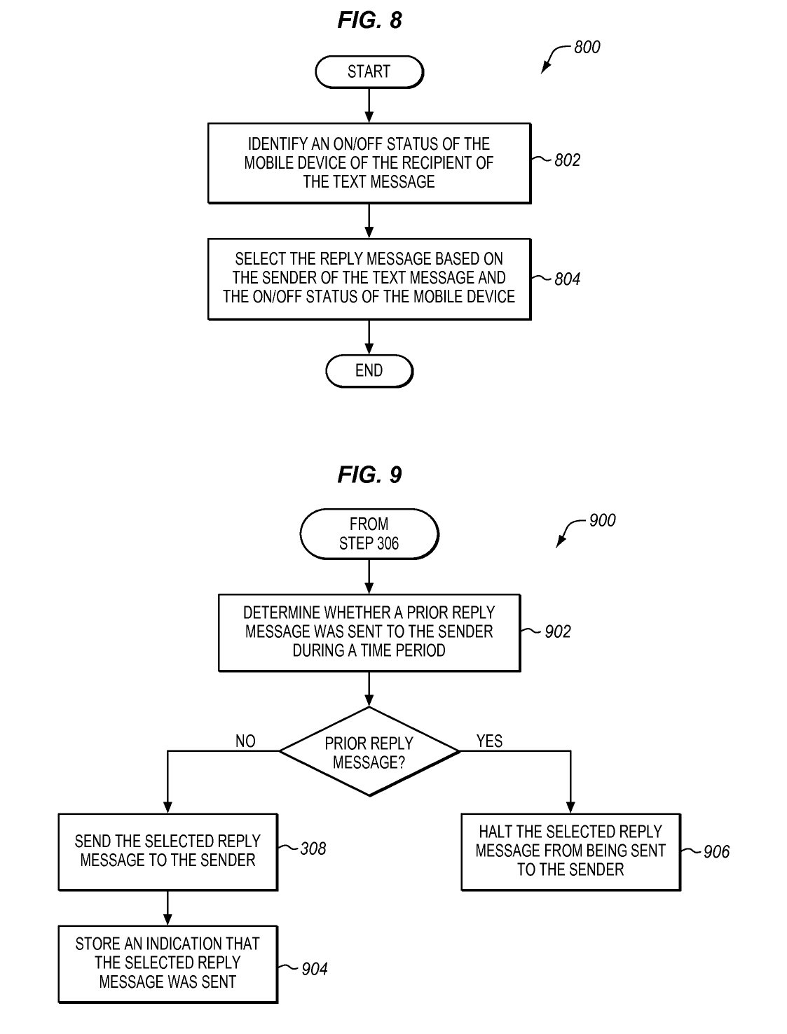

In another embodiment, the reply criteria may additionally include the on/off status of the mobile device 112 of the recipient. FIG. 8 is a flow chart illustrating a method 800 of selecting the reply message based further on the on/off status of the mobile device 112 of the recipient in an exemplary embodiment. In step 802, control system 204 determines an on/off status of the mobile device 112 of the recipient (see also FIG. 2). For example, control system 204 may query a Home Location Register (HLR), a Home Subscriber Server (HSS), or another type of subscriber database (not shown) in mobile network 100 to determine the on/off status of the mobile device 112. In step 804, control system 204 selects the reply message based on the sender of the text message and the on/off status of the mobile device 112.

In addition to the embodiments above, there may be other reply criteria defined by Party B, such as a type of the text message (e.g., a Wireless Application Protocol (WAP) message), whether the text message was sent to a single recipient or a group of recipients, whether particular content is included in the text message, etc. Control system 204 may process any of these reply criteria or other reply criteria, alone or in combination, when selecting the reply message for the text message.

Before sending the reply message in step 308 (see FIG. 3), control system 204 may determine whether a prior reply message was sent to this sender. For the automatic reply feature described herein, Party B may define whether a reply message is sent one time to the same sender during a time period, or whether multiple reply messages may be sent to the same sender during the time period. If Party B has selected the former, then control system 204 may operate as described in FIG. 9 before sending the reply message.

FIG. 9 is flow chart illustrating a method 900 of determining whether to send the selected reply message in an exemplary embodiment. Before sending the reply message to the sender (see step 308 of FIG. 3), control system 204 determines whether a prior reply message was sent to the sender during a time period in step 902. As an example, each time a reply message is sent to a sender, control system 204 may store an indication that the reply message was sent to the sender, and may store a timestamp for the reply message. Control system 204 can then determine whether a prior reply message was sent to the sender during the time period based on the indications and the timestamps previously stored.

If the determination is that a prior reply message was not sent during the time period, then control system 204 sends the selected reply message to the sender as in step 308 (see also FIG. 3). Control system 204 also stores an indication that the selected reply message was sent to the sender in step 904, along with a timestamp. If the determination is that a prior reply message was sent during the time period, then control system 204 halts the selected reply message from being sent to the sender of the text message in step 906.

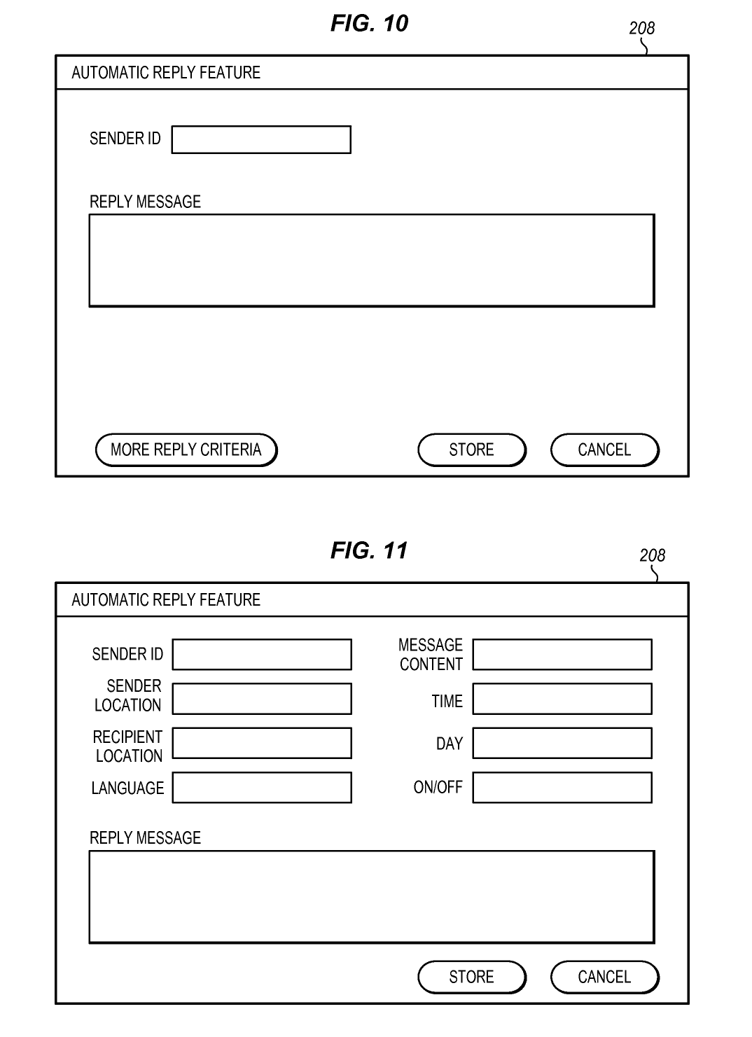

In order to allow Party B (see FIG. 1) to predefine the reply criteria described above, automatic reply system 104 is able to provide a web-based interface or another type of user interface that is accessible to Party B. As shown in FIG. 2, control system 204 is able to provide user interface 208. User interface 208 allows Party B to define the reply criteria and the reply messages that are associated with the reply criteria. FIG. 10 illustrates user interface 208 provided for the automatic reply feature in an exemplary embodiment. In this embodiment, user interface 208 allows Party B to enter sender IDs (e.g., an MDN, an IP address, a URL, an email address, a name, etc), and a reply message for each of the sender IDs. For example, Party B may enter a directory number of “NPA-NXX-0001” and a reply message of “I am in a meeting until 10 a.m.”. In response to the user input, control system 204 stores an entry in storage system 206 that includes the sender ID and the reply message (see FIG. 2). Control system 204 stores the entry as indexed by or otherwise associated with a sender ID. This makes the entry searchable based on the sender ID. Party B may predefine additional reply messages for other senders. For example, Party B may enter a directory number of “NPA-NXX-0002” and a reply message of “I am out of the country until June 15”. Control system 204 then stores another entry in storage system 206 that includes the sender ID and the reply message (see FIG. 2). When control system 204 selects the reply message, control system 204 accesses the entries in storage system 206 based on the sender of the text message.

If Party B wants to define additional reply criteria in addition to the sender ID, then user interface 208 allows Party B to do so by selecting the “More reply criteria” button. FIG. 11 illustrates the user interface 208 with additional reply criteria in an exemplary embodiment. In FIG. 11, Party B has additional options for predefining the reply criteria, which includes a sender location, a recipient location, a language of the text message, content in the text message (subject or body), a time, a day, and an on/off status of the mobile device 112 of the recipient. User interface 208 may include any other desired reply criteria.

### EXAMPLE

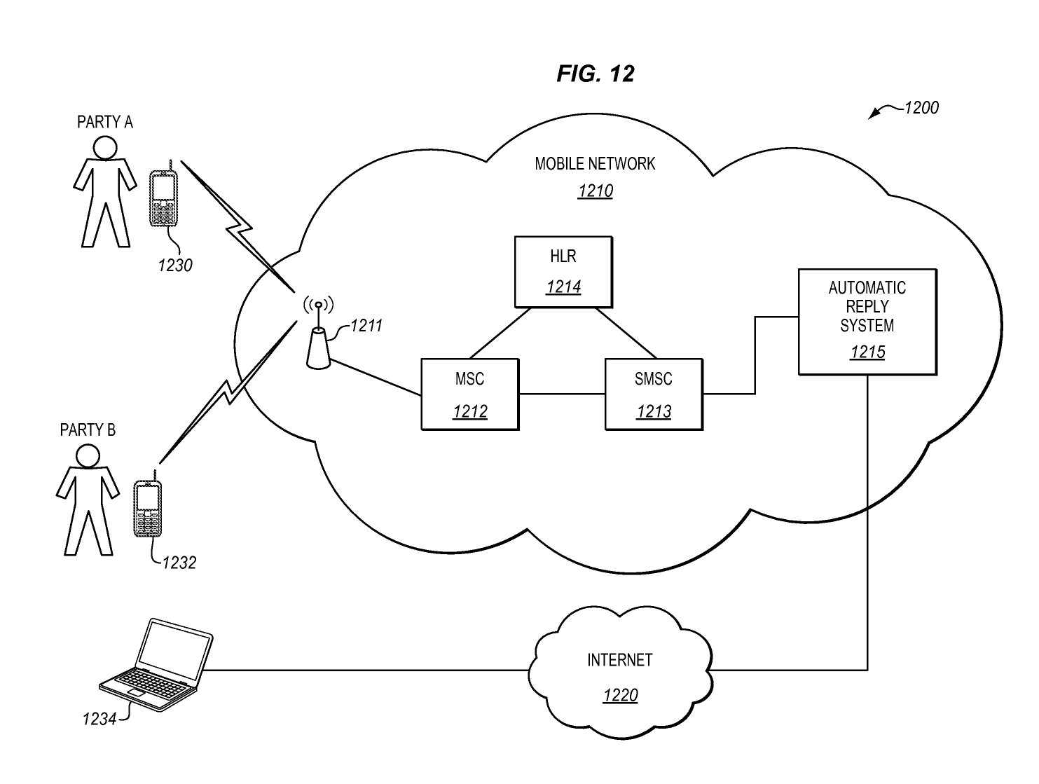

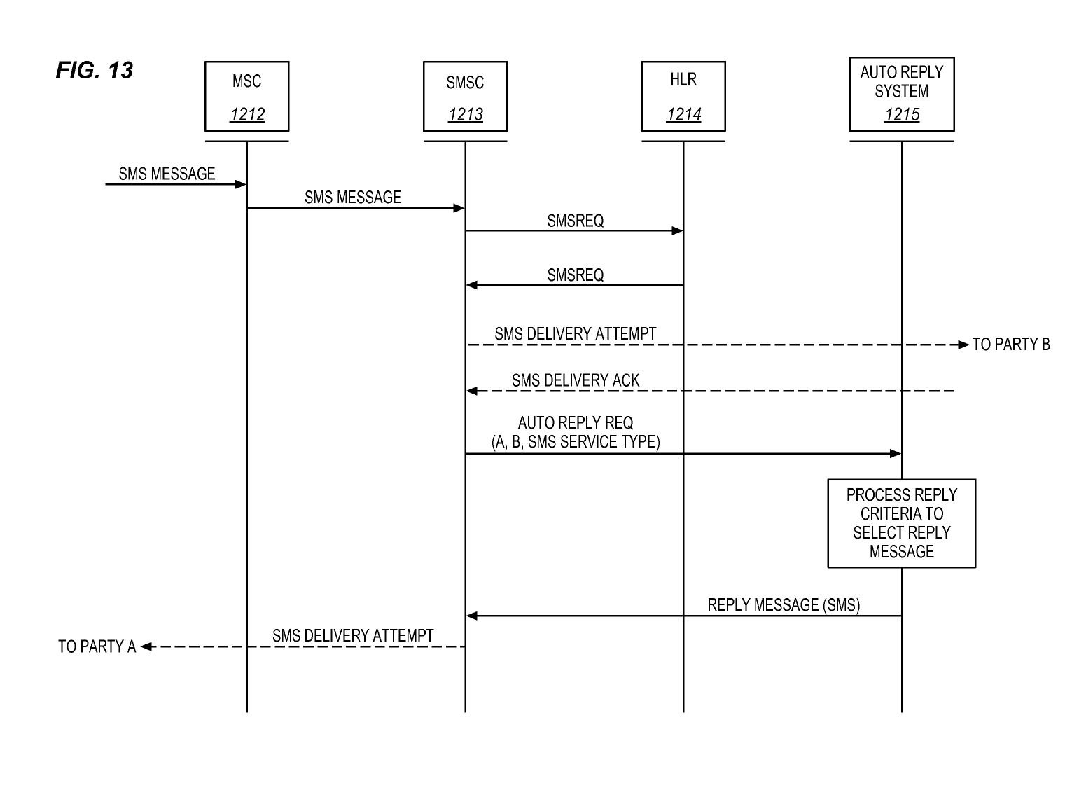

FIGS. 12-13 illustrate an example of a providing personalized reply messages to senders of text messages. FIG. 12 illustrates a communication system 1200 in an exemplary embodiment. Communication system 1200 includes a mobile network 1210 and an internet 1220. Mobile network 1210 includes a base station 1211, a Mobile Switching Center (MSC) 1212, a Short Message Service Center (SMSC) 1213, a Home Location Register (HLR) 1214, and an automatic reply system 1215. Base station 1211 enables communication with mobile devices 1230 and 1232 over an air interface. Although one base station 1211 is shown, mobile network 1210 may include many more base stations. MSC 1212 is the serving node for mobile devices, and is responsible for handling voice calls, SMS, and other services. SMSC 1213 handles SMS messages within mobile network 1210. HLR 1214 is a central subscriber database that stores subscription information and other details, such as in subscriber profiles, of mobile devices that are authorized to use mobile network 1210. Automatic reply system 1215 provides an automatic reply feature for SMS subscribers in mobile network 1210.

In this embodiment, Party B has subscribed to SMS service in mobile network 1210, and has also subscribed to an automatic reply feature. As part of the automatic reply feature, Party B predefines reply criteria which specify the conditions for selecting a personalized reply message to send to a sender of a text message. To do so, Party B accesses a web-based interface of automatic reply system 1215 over the internet 1220 via PC 1234. Some exemplary web-based interfaces are shown in FIGS. 10-11. Party B may also access a user interface of automatic reply system 1215 through SMS messages. Party B then activates the automatic reply feature at some point.

Assume further that Party A uses mobile device 1230 to send an SMS message to Party B. FIG. 13 is a message diagram illustrating an example of providing a personalized reply message in an exemplary embodiment. In response to the SMS message being sent, MSC 1212 receives the SMS message (through base station 1211). MSC 1212 then forwards the SMS message to SMSC 1213. SMSC 1213 validates the sender (Party A) of the SMS message, and also determines if the recipient (Party B) has subscribed to an automatic reply feature. With the sender valid, SMSC 1213 sends a Short Message Service request (SMSREQ) to HLR 1214. In response to the SMSREQ, HLR 1214 determines whether mobile device 1232 is active or inactive, and also determines routing information for mobile device 1232. HLR 1214 then responds to SMSC with an SMS response (smsreq) that includes the status of mobile device 1232 and the routing information. SMSC 1213 then implements store-and-forward processing of the SMS message, which includes storing the SMS message and attempting to deliver the SMS message to the mobile device 1232 of Party B if mobile device 1232 is active.

Because Party B has activated an automatic reply feature, SMSC 1213 also sends an automatic reply request to automatic reply system 1215 that includes information on the SMS message. The information on the SMS message includes a sender ID, a recipient ID, an SMS service ID, a delivery status, etc. In response to the automatic reply request, automatic reply system 1215 processes the reply criteria defined by Party B to select a reply message to send to Party A for the automatic reply feature. The reply criteria, at a minimum, include a sender ID that is used to select the reply message. Automatic reply system 1215 then sends the selected reply message to SMSC 1213 in SMS protocol. In response to receiving the reply message, SMSC 1213 implements store-and-forward processing of the reply message, which includes storing the reply message, and attempting to deliver the reply message to the mobile device 1230 of Party A.

Because Party B is able to define the reply criteria for the automatic reply feature, automatic reply system 1215 is able to send a personalized reply message to Party A. If another SMS message is received from another party while the automatic reply feature is activated, automatic reply system 1215 would again select a reply message based on the sender ID that is personalized for the sender. Thus, each reply message that is sent in response to an SMS message is personalized to the sender of the SMS message. This gives Party B flexibility in the content that is provided to senders of SMS messages.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A system comprising:
a network interface operable to receive information on a text message sent to a recipient that has activated an automatic reply feature; and
a control system operable to process the text message information to identify a sender of the text message, to select a reply message predefined by the recipient based on the sender of the text message, and to send the selected reply message to the sender of the text message through the network interface.

2. The system of claim 1 wherein:
the control system is further operable to identify a location of the sender of the text message, and to select the reply message based on the sender of the text message and the location of the sender.

3. The system of claim 1 wherein:
the control system is further operable to identify a location of the recipient, and to select the reply message based on the sender of the text message and the location of the recipient.

4. The system of claim 1 wherein:
the control system is further operable to process the text message information to determine information on a time/day that the text message was sent, and to select the reply message based on the sender of the text message and the time/day information.

5. The system of claim 1 wherein:
the control system is further operable to process the text message information to identify a language of the text message, and to select the reply message based on the sender of the text message and the language of the text message.

6. The system of claim 1 wherein:
the control system is further operable to identify an on/off status of a mobile device of the recipient, and to select the reply message based on the sender of the text message and the on/off status of the mobile device of the recipient.

7. The system of claim 1 further comprising:
a user interface operable to allow the recipient to enter sender identities and a reply message that is predefined for each of the sender identities; and
a storage system operable to store entries that associate the sender identities with the reply messages;
wherein the control system is further operable to access the entries in the storage system to select the reply message based on the sender of the text message.

8. The system of claim 1 wherein:
the control system is further operable to store an indication that the selected reply message was delivered to the sender of the text message.

9. The system of claim 1 wherein:
the control system is further operable to determine whether a prior reply message was sent to the sender during a time period, and to halt the selected text message from being sent to the sender responsive to a determination that the prior reply message was sent.

10. A method comprising:
receiving information on a text message sent to a recipient that has activated an automatic reply feature;
processing the text message information to identify a sender of the text message;
selecting a reply message predefined by the recipient based on the sender of the text message; and
sending the selected reply message to the sender of the text message.

11. The method of claim 10 further comprising:
identifying a location of the sender of the text message;
wherein selecting the reply message comprises selecting the reply message based on the sender of the text message and the location of the sender.

12. The method of claim 10 further comprising:
identifying a location of the recipient;
wherein selecting the reply message comprises selecting the reply message based on the sender of the text message and the location of the recipient.

13. The method of claim 10 further comprising:
processing the text message information to determine information on a time/day that the text message was sent;
wherein selecting the reply message comprises selecting the reply message based on the sender of the text message and the time/day information.

14. The method of claim 10 further comprising:
processing the text message information to identify a language of the text message;
wherein selecting the reply message comprises selecting the reply message based on the sender of the text message and the language of the text message.

15. The method of claim 10 further comprising:
identifying an on/off status of a mobile device of the recipient;
wherein selecting the reply message comprises selecting the reply message based on the sender of the text message and the on/off status of the mobile device of the recipient.

16. The method of claim 10 further comprising:
providing a user interface that allows the recipient to enter sender identities and a reply message that is predefined for each of the sender identities;
storing entries that associate the sender identities with the reply messages; and
accessing the entries to select the reply message based on the sender of the text message.

17. The method of claim 10 further comprising:
storing an indication that the selected reply message was delivered to the sender of the text message.

18. The method of claim 10 further comprising:
determining whether a prior reply message was sent to the sender during a time period; and
halting the selected text message from being sent to the sender responsive to a determination that the prior reply message was sent.

19. A mobile network comprising:
a message center operable to receive a text message sent to a recipient that has activated an automatic reply feature; and
an automatic reply system operable to receive information on the text message from the message center, to process the text message information to identify a sender of the text message, to select a reply message predefined by the recipient based on the sender of the text message, and to send the selected reply message to the sender of the text message through the message center.

20. The mobile network of claim 19 wherein:
the automatic reply system is further operable to provide a user interface that allows the recipient to enter sender identities and a reply message that is predefined for each of the sender identities, to store entries that associate the sender identities with the reply messages, and to access the entries to select the reply message based on the sender of the text message.
